(19) United States
(12) Patent Application Publication
(10) Pub. No.: US 2024/0157771 A1
(43) Pub. Date: May 16, 2024

(54) SLIDING DOOR SYSTEM FOR A VEHICLE

(71) Applicants: Lawrence M. PLOURDE, JR., Macomb, MI (US); David W. CUMMINGS, Clinton Township, MI (US); MAGNA INTERNATIONAL INC., Aurora (CA)

(72) Inventors: Lawrence M. PLOURDE, JR., Macomb, MI (US); David W. CUMMINGS, Clinton Township, MI (US)

(21) Appl. No.: 18/282,325

(22) PCT Filed: Mar. 29, 2022
(86) PCT No.: PCT/US2022/022312

§ 371 Date: Sep. 15, 2023

Related U.S. Application Data
(60) Provisional application No. 63/167,242, filed on Mar. 29, 2021.

(51) Int. Cl. B60J 5/04; B60J 5/06; E05D 15/10

(52) U.S. Cl. CPC B60J 5/0479; B60J 5/06; E05D 15/1047; E05D 2015/1049; E05Y 2201/624; E05Y 2201/684; E05Y 2201/688; E05Y 2900/531

(57) ABSTRACT

A sliding door system for a vehicle includes a door frame defining a door opening and a sliding door covering at least a portion of the door opening in a closed position. An upper door slide assembly and a lower door slide assembly collectively interconnect the sliding door to the door frame and each are configured to slide the sliding door relative to the door frame from the closed position to an open position to dispose the sliding door either forward or rearward of the door opening. The lower door slide assembly includes a lower track extending along the sliding door and a lower hinge assembly pivotably connected to the door frame and slideably mated with the lower track for effectuating pivoting and sliding movement of the sliding door between the open and closed positions.

### CROSS-REFERENCE TO RELATED APPLICATION

This PCT International Patent Application claims the benefit of and priority to U.S. Provisional Patent Application Ser. No. 63/167,242, filed Mar. 29, 2021, titled “Sliding Door System For A Vehicle,” the entire disclosure of which is hereby incorporated by reference in its entirety.

### BACKGROUND OF THE INVENTION

### 1. Field of the Invention

The present invention relates to a sliding door system and, more particularly, a sliding door system for a vehicle including at least a front sliding door or a rear sliding door, and preferably both.

### 2. Related Art

This section provides background information related to the present disclosure which is not necessarily prior art.

Vehicle doors are typically located within a door frame of a vehicle body and include an outer panel, an inner panel spaced laterally from the outer panel to provide a central space (also known as a window receiving well) and a window frame secured to the outer panel. Various components, such as a latch mechanism and a window channel, are secured to at least one of the inner and outer panels within the central space. Many types of vehicles include a pair of front doors and a pair of rear doors. Historically, these vehicle doors open by either pivotal or sliding movement between an open position and a closed position and require some form of structural component (such as a pillar) to be located between the front doors and the rear doors. While sliding doors provide some benefits over the pivot-type doors, such as less clearance requirements to open, they are not without shortcomings. For example, sliding doors are harder to seal against the door frame which can result in both noise and susceptibility to leakage. Additionally, existing sliding doors typically encroach into the floor structure, and when in the open position, still present structural pillars in the door opening which limit ingress and egress into the vehicle interior. Accordingly, there is a continuing need to develop optimized packaging of components and structures for sliding door systems.

### SUMMARY OF THE INVENTION

A sliding door system for a vehicle includes a door frame defining a door opening, and at least one sliding door covering at least a portion of the door opening in a closed position. An upper door slide assembly and a lower door slide assembly collectively interconnect the sliding door to the door frame and each are configured to collectively effectuate sliding movement of the sliding door relative to the door frame from the closed position to an open position which disposes the sliding door either forward or rearward of the door opening. The lower door slide assembly includes a lower track extending along the sliding door and a lower hinge assembly pivotably connected to the door frame and slideably mated with the lower track. This arrangement of the lower door slide assembly, with the lower hinge assembly mounted on the door frame and the lower track mounted on the door, provides for a sliding door guidance system which eliminates the prior art packaging requirements that encroached into the floor structure of the vehicle body.

The lower door slide assembly preferably includes a pair of lower pivots disposed in spaced relationship with one another between the door frame and the lower track for establishing a dual-pivoting movement of the lower hinge assembly during the sliding movement of the sliding door between the open and closed positions. This dual-pivot lower hinge assembly provides for outboard and forward movement of the sliding door, and similarly improves on the prior art packaging requirements for sliding door systems.

### BRIEF DESCRIPTION OF THE DRAWINGS

Other aspects and advantages of the present disclosure will be readily appreciated, as the same becomes better understood by reference to the following detailed description when considered in connection with the accompanying drawings wherein:

FIG. 1 is a side view of a prior art automobile that includes a structural pillar located between a front door and a rear door that are both pivotable between an open position and a closed position;

FIG. 2 is a side view of a sliding door system for a vehicle including a front sliding door and a rear sliding door and generally illustrating an upper and lower front door slide assembly interconnecting the front sliding door to a door frame and an upper and lower rear door slide assembly interconnecting the rear sliding door to the door frame;

FIG. 3 is a top view of the sliding door system disposed in the open position and illustrating a lower hinge assembly of both lower door slide assemblies including a first lower pivot bracket secured to the door frame to establish a first lower pivot, a second lower pivot bracket spaced from the first lower pivot bracket to establish a second lower pivot, and a linkage extending between the first and second pivot brackets and disposed at a generally transverse angle relative to the sliding door and the door frame in the open position;

FIG. 4 is a perspective view of the upper and lower front door slide assembly interconnected to the door frame;

FIG. 5 is a perspective and isolated view of the upper front door slide assembly;

FIG. 6 is a perspective and isolated view of the lower front door slide assembly when the front sliding door is in the closed position;

FIGS. 7A and 7B are perspective and isolated views of the lower front door slide assembly first pivoting and then sliding from the closed position to the open position;

FIG. 8 is a perspective view of the lower front door slide assembly when the front sliding door is in the closed position;

FIGS. 9A-9B are perspective views of the lower front door slide assembly first pivoting and then sliding from the closed position to the open position;

FIG. 10 is a perspective view of the upper and lower rear door slide assemblies interconnected to the door frame of the vehicle body;

FIG. 11 is a perspective and isolated view of the upper rear door slide assembly;

FIG. 12 is a perspective and isolated view of the lower rear door slide assembly when the rear sliding door is in the closed position;

FIGS. 13A and 13B are perspective and isolated views of the lower rear door slide assembly pivoting and then sliding from the closed position to the open position;

FIG. 14 is a perspective view of the lower rear door slide assembly when the rear sliding door is in the closed position;

FIGS. 15A and 15B are perspective views of the lower rear door slide assembly pivoting and then sliding from the closed position to the open position;

FIG. 16A is a perspective view of the lower rear door slide assembly and the rear sliding door in the closed position;

FIG. 16B is a perspective view of the lower front door slide assembly and the front sliding door in the closed position; and

FIG. 17 is a top view of the lower rear door slide assembly connected to the door frame of the vehicle body.

### DESCRIPTION OF THE ENABLING EMBODIMENTS

Example embodiments will now be described more fully with reference to the accompanying drawings. In general, the subject embodiments are directed to a sliding door system for a vehicle including at least one of a front sliding door or a rear sliding door, and preferably both. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

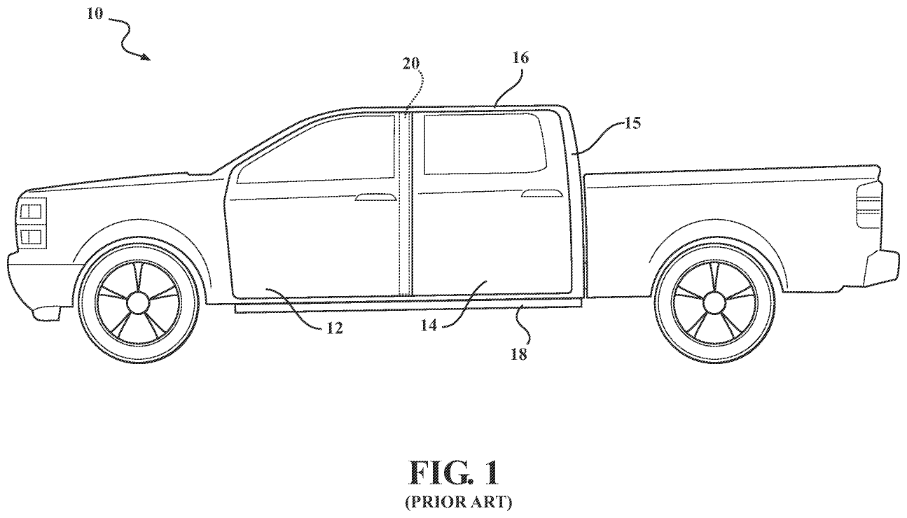

Referring initially to FIG. 1, an exemplary prior art automobile 10 is illustrated as a pick-up truck having a pair of front doors 12 and a pair of rear doors 14. Each door 12, 14 is attached to a door frame 15 extending between a roof panel 16 and a floor sub-frame 18. A structural pillar 20 is typically a component of the vehicle frame and extends substantially vertically between the roof panel 16 and floor sub-frame 18 to provide both axial and transverse support. Commonly, the structural pillar 20 includes a B-pillar located between each of the front doors 12 and the rear doors 14. The structural pillar 20 oftentimes forms vertical sections of the door frame 15 and the doors 12, 14 open and close via a pivot connection to the door frame 15.

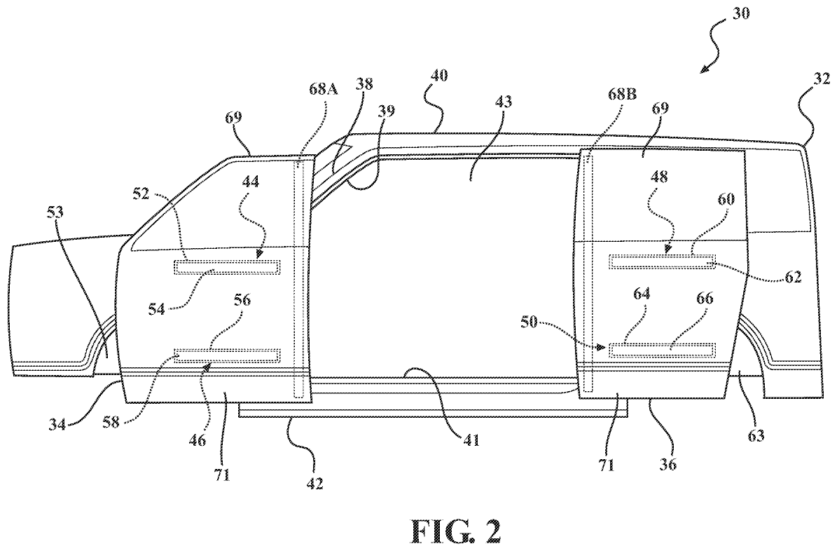

FIG. 2 is a side view of the sliding door system 30 for a vehicle body 32 in accordance with an aspect of the subject disclosure and including a front sliding door 34 and a rear sliding door 36. Each sliding door 34, 36 is attached to a door frame 38 which extends between a top frame portion 39 disposed adjacent a roof panel 40 and bottom frame portion 41 disposed adjacent a floor sub-frame 42 to define a door frame opening 43. As will be explained in more detail below, each of the front and rear sliding doors 34, 36 cover at least a portion of the door opening 43 in a closed position and are each slideable from the closed position to an open position to dispose the front and rear sliding doors 34, 36 in respective forward or rearward positions defined relative to the door opening 43 (such as illustrated in FIG. 2). More specifically, when the front sliding door 34 is disposed in the open position, the front sliding door 34 is slid forward of the door frame 38 and located forward of the door opening 43 and when the rear sliding door 36 is in the open position, the rear sliding door 36 is slid rearward of the door frame 38 and located rearward of the door opening 43. As will be appreciated in view of the following more detailed disclosure, the sliding door system 30 for a vehicle including a front sliding door 34 and a rear sliding door 36 is intended for providing a strong, protective, and reliable design that permits a large range of motion for both the front sliding door 34 and the rear sliding door 36, such that rear or leading edges of the respective front and rear sliding doors 34, 36 in their open positions are disposed ahead of and in a non-obstructing position relative to the step-in locations into the vehicle body's interior.

As best illustrated in FIGS. 2, 4 and 8-9, the front sliding door 34 is interconnected to the door frame 38 of the vehicle body 32 via an upper front door slide assembly 44 which is disposed adjacent or closer to the top frame portion 39 and a lower front door slide assembly 46 which is disposed adjacent or closer to the bottom frame portion 41. Likewise, as best illustrated in FIGS. 2, 10 and 14-15, the rear sliding door 36 is interconnected to the door frame 38 of the vehicle body 32 via an upper rear door slide assembly 48 which is disposed adjacent or closer to the top frame portion 39 and a lower rear door slide assembly 50 which is disposed adjacent or closer to the bottom frame portion 41. As will be described in more detail below, the upper and lower door slide assemblies 44, 46, 48, 50 are configured to collectively slide their respective front or rear sliding doors 34, 36 relative to the door frame 38 between their open and closed positions.

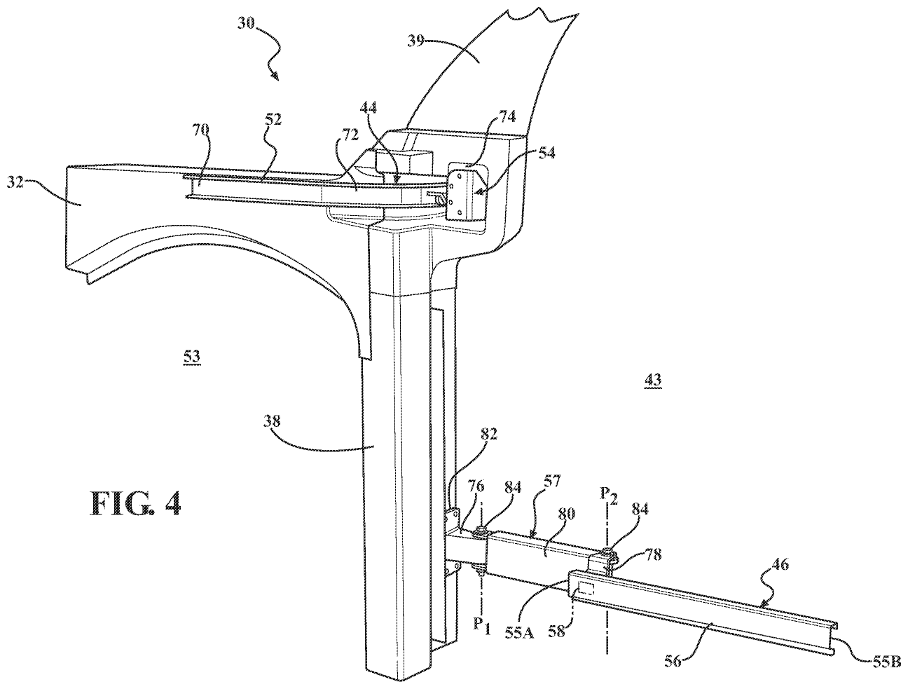

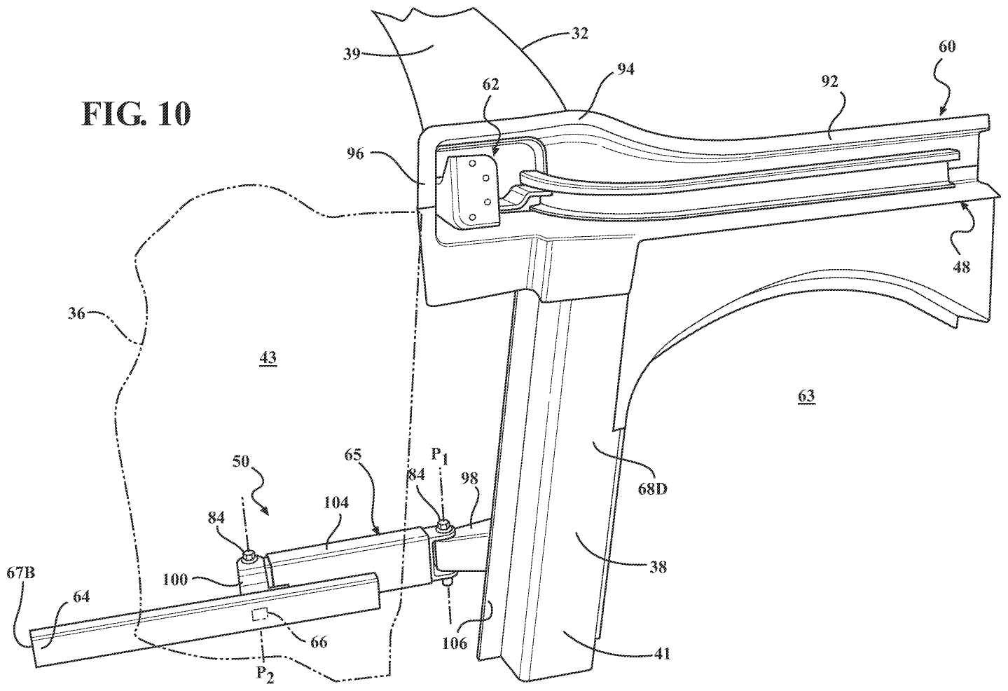

As best illustrated in FIG. 4, the upper front door slide assembly 44 includes an upper front rail or track 52 connected to and extending along the vehicle body 32 and away from the door opening 43, such as above the front wheel well area 53 of the vehicle body 32, and an upper front carriage 54 that is connected to the front sliding door 34 (although not expressly shown in FIG. 4). The upper front carriage 54 slides within the upper front rail or track 52 relative to the vehicle body 32 during movement of the sliding front door 34 between the open and closed positions. Similarly, as best illustrated in FIG. 10, the upper rear door slide assembly 48 includes an upper rear rail or track 60 connected to and extending along the vehicle body 32 and away from the door opening 43, such as above the rear wheel well area 63 of the vehicle body 32, and a upper rear carriage 62 that is connected to the rear sliding door 36 (although not expressly shown in FIG. 10). The upper rear carriage 62 slides within the upper rear rail or track 60 during movement of the sliding rear door 36 between the open and closed positions.

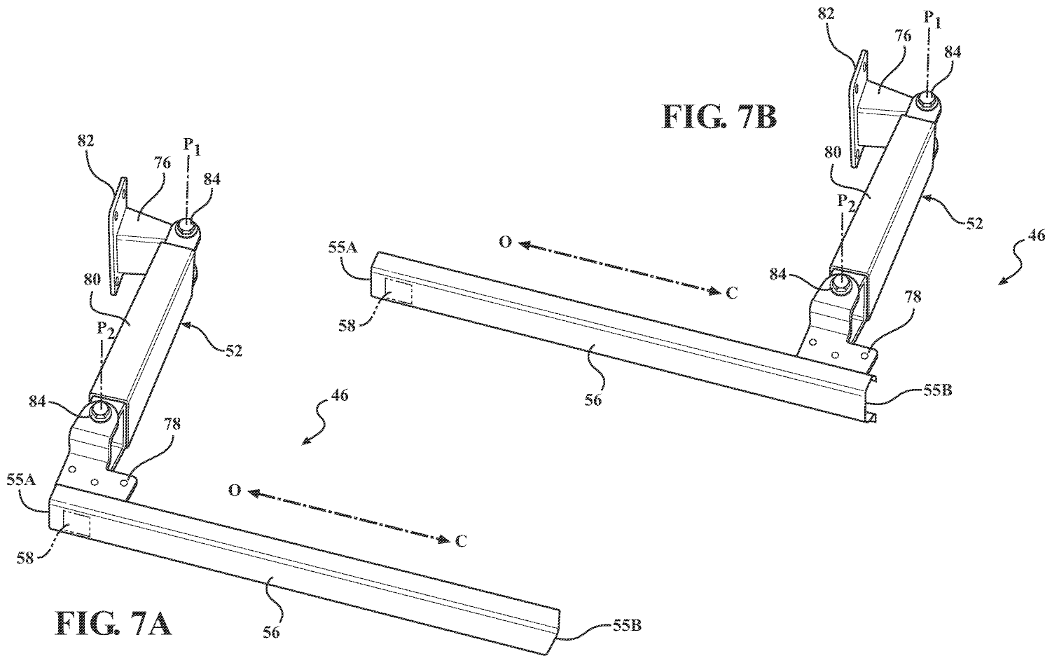

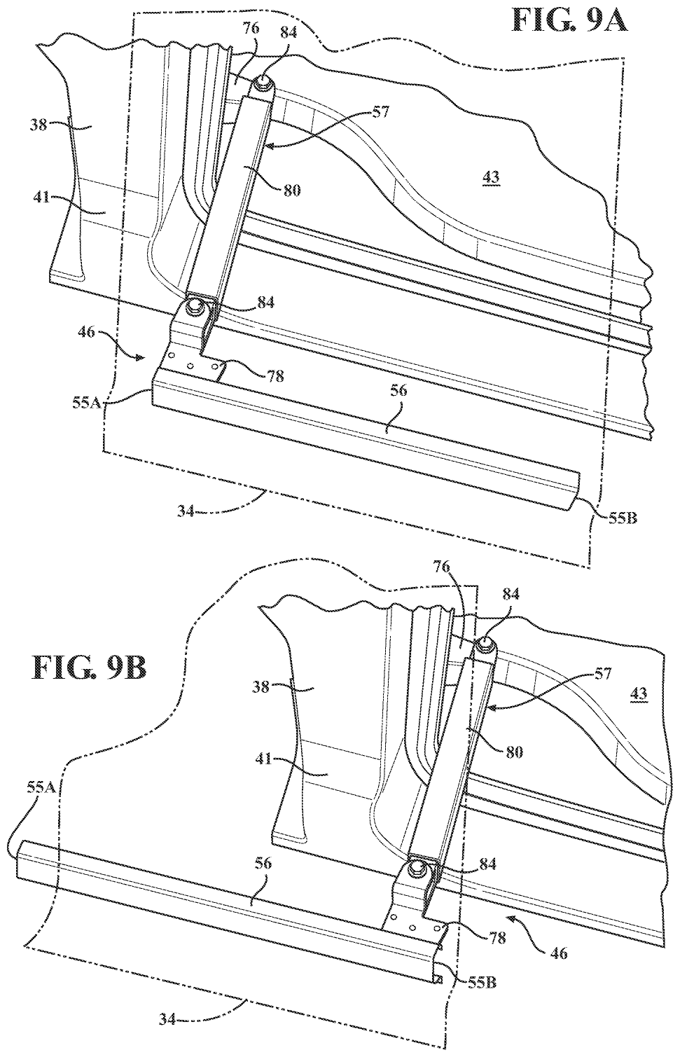

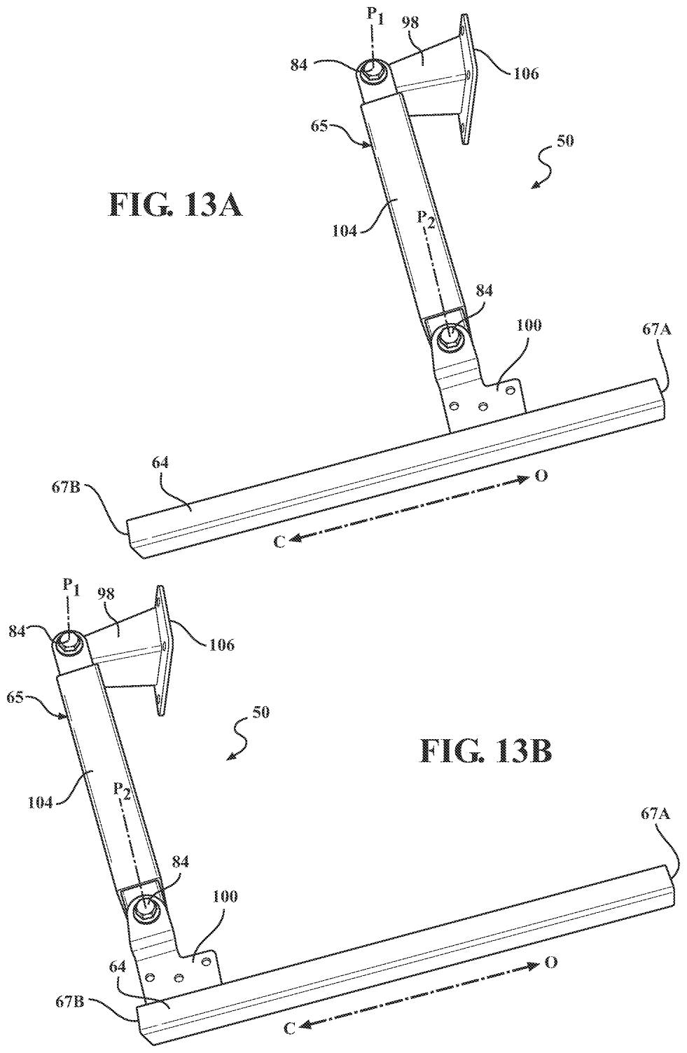

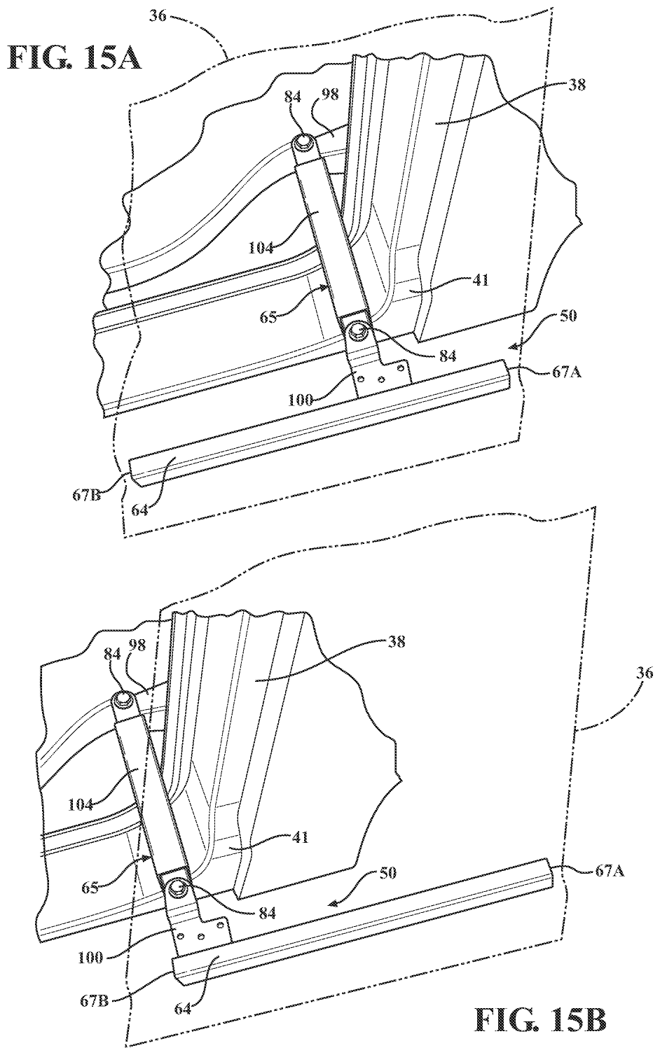

As best illustrated in FIGS. 2, 4 and 6-9, the lower front door slide assembly 46 includes a lower front rail or track 56 connected to and extending along the front sliding door 34 between a first lower front track end 55A and a second lower front track end 55B. The lower front door slide assembly 46 also includes a lower hinge assembly 57 which is pivotably connected to the door frame 38 of the vehicle body 32 and slideably mated with the lower front rail or track 56 for effectuating pivoting and sliding movement of the sliding door between the open and closed positions (such as sequentially illustrated in FIGS. 7A-7B and 9A-9B). Similarly, as best illustrated in FIGS. 10 and 12-15, the lower rear door slide assembly 50 includes a lower rear rail or track 64 connected to and extending along the rear sliding door 36 between a first lower rear track end 67A and a second lower rear track end 67B. The lower rear door slide assembly 50 also includes a lower rear hinge assembly 65 which is pivotably connected to the door frame 38 of the vehicle body 32 and slideably mated with the lower rear rail or track 64 for effectuating pivoting and sliding movement of the sliding door between the open and closed positions (such as sequentially illustrated in FIGS. 13A-13B and 15A-15B). As illustrated in FIGS. 2, 4, 6-10 and 12-15, each of the lower front and rear hinge assemblies 57, 65 include a pair of lower pivots P₁, P₂ disposed in spaced relationship with one another between the door frame 38 and the respective lower front and rear tracks 56, 64 for establishing a dual-pivoting movement of the lower front and rear hinge assemblies 57, 65 during the sliding movement of the respective front and rear sliding doors 34, 36 between the open and closed positions. As best illustrated in FIGS. 7A-7B, 9A-9B, 13A-13B, and 15A-15B, this dual-pivot hinge arrangement provides for outboard and forward or rearward movement of the front and rear sliding doors 34, 36.

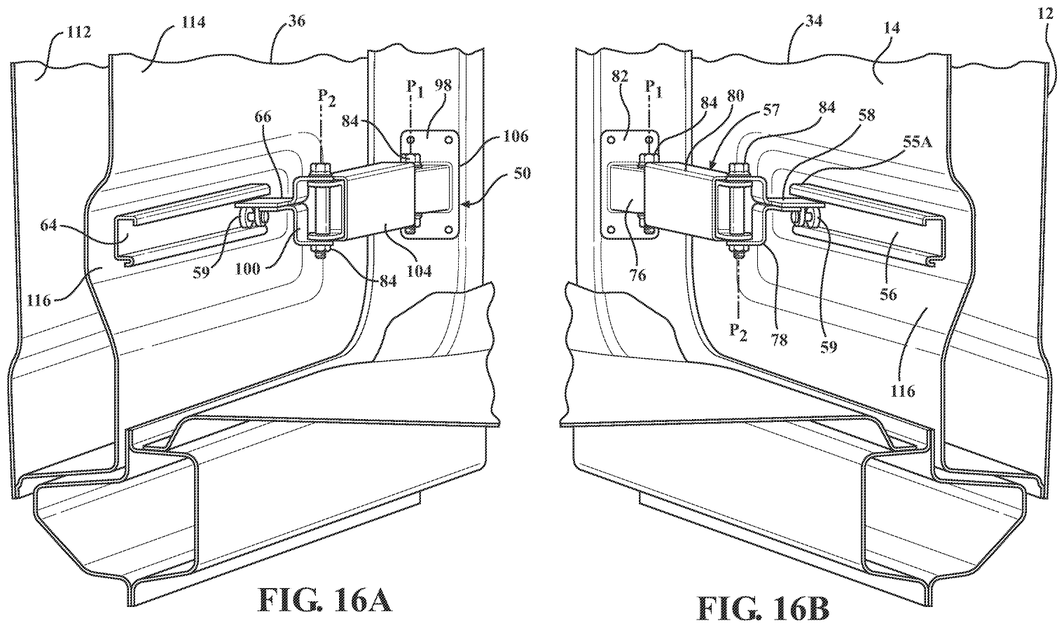

As best illustrated in FIGS. 4 and 6-9, the lower front hinge assembly 57 of the lower front door slide assembly 46 includes a first front pivot bracket 76 secured to the door frame 38 establishing the first lower pivot P₁ and a second front pivot bracket 78 spaced from the first front pivot bracket 76 establishing the second pivot P₂. A front linkage 80 extends between the first and second pivot brackets 76, 78, and the second front pivot bracket 78 is slideably mated with the lower front rail 56 via a lower front carriage 58. As best illustrated in FIG. 16, the lower front carriage 58 preferably includes a wheel 59 disposed within the lower front rail 56, and thus slides within the lower front rail 56 relative to the vehicle body 32. Although FIG. 16 illustrates a perspective view of the lower rear door slide assembly 50, the same arrangement for the lower rear carriage 66 is utilized for the lower front carriage 58. As best illustrated in FIG. 4, the first front pivot bracket 76 is connected to the door frame 38 of the vehicle body 32 with a brace 82 and pivotally connected to the front linkage 80 with a pivot pin 84 extending along the first pivot P₁. The second front pivot bracket 78 is pivotally connected to the front linkage 80 with a pivot pin 84 extending along the second pivot P₂.

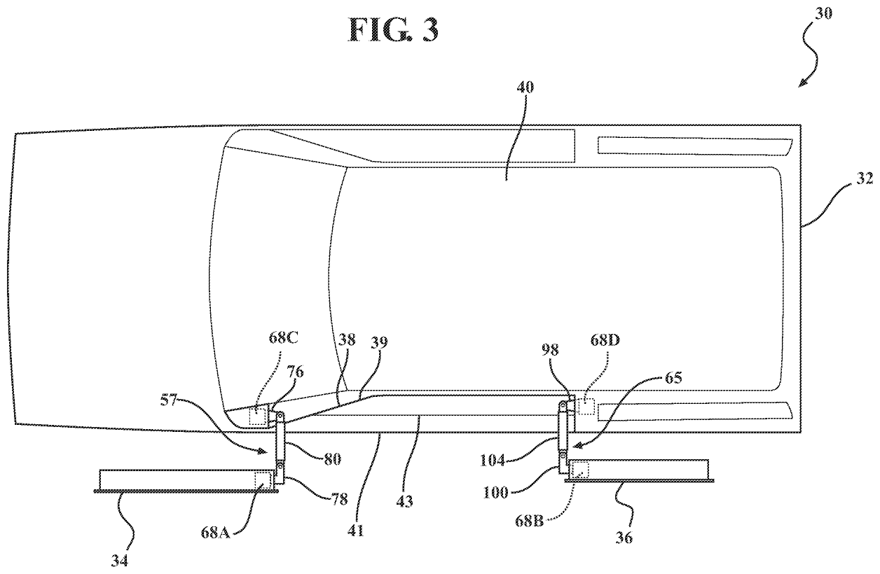

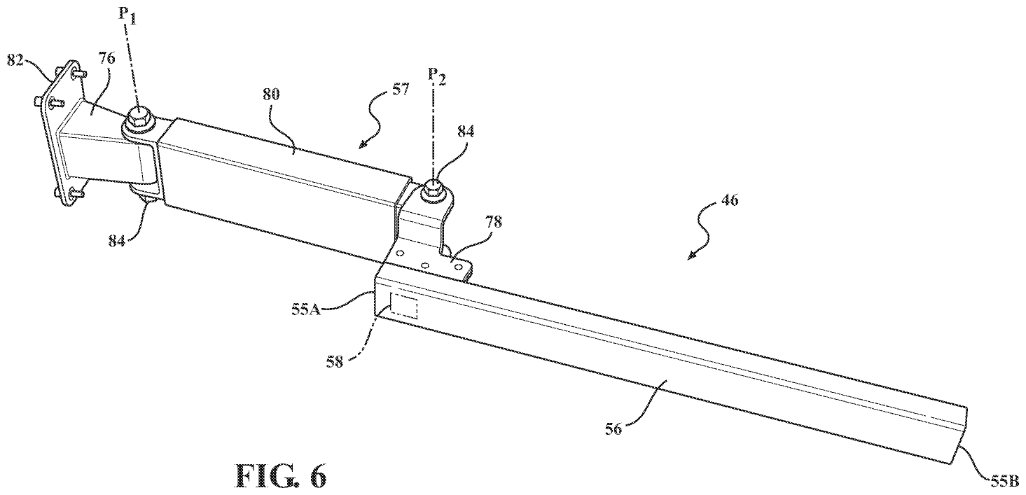

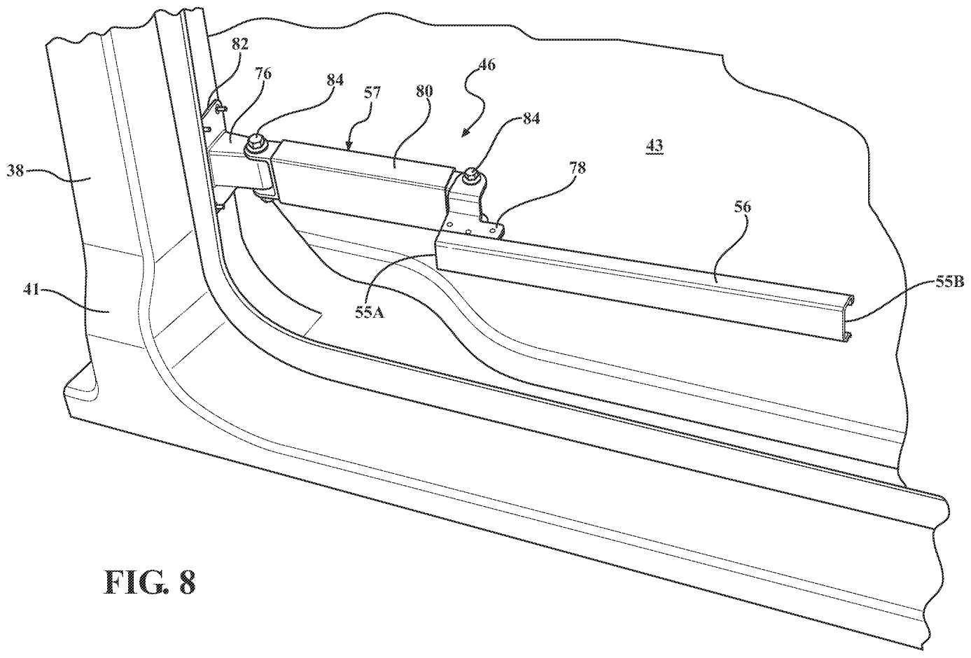

FIGS. 7A, 7B, 9A and 9B illustrate the lower front door slide assembly 46 when the front sliding door 34 is moved into the open position to disposed the front linkage 80 at a generally transverse angle from the lower front rail or track 56 as well as the vehicle body 32 and the front sliding door 34 (providing a similar range of movement as the arched portion 72 of the upper front rail 52 in the upper front door slide assembly 44, as will be described in more detail below). FIG. 3 is a top view of the sliding door system 30 more clearly illustrating the front linkage 80 disposed at this transverse angle. As illustrated by the arrow, movement of the front sliding door 34 in the “O” direction slides the front sliding door 34 along the vehicle body 32. In some embodiments, the front sliding door 34 may move completely forward of the door frame 38. FIGS. 6 and 8 illustrate the lower front door slide assembly 46 when the front sliding door 34 is in the closed position wherein the front linkage 80 is disposed at a parallel angle from the lower front rail or track 56 (providing a similar range of movement as the straight portion 70 of the upper front rail 52 in the upper front door slide assembly 44, as will be described in more detail below).

As best illustrated in FIGS. 10 and 12-14, the lower rear hinge assembly 65 of the lower rear door slide assembly 50 includes a first rear pivot bracket 98 secured to the door frame 38 establishing the first lower pivot P₁ and a second rear pivot bracket 100 spaced from the first rear pivot bracket 98 establishing the second lower pivot P₂. A rear linkage 104 extends between the first and second rear pivot brackets 98, 100, and the second rear pivot bracket 100 is slideably mated with the lower rear rail or track 64 via a lower rear carriage 66. As best illustrated in FIG. 16A, the lower rear carriage 66 preferably includes a wheel 59 disposed within the lower rear rail or track 64, and thus slides within the lower rear rail or track 64 relative to the vehicle body 32. As best illustrated in FIG. 10, the first rear pivot bracket 98 is connected to the door frame 38 of the vehicle body 32 with a brace 106 and pivotally connected to the rear linkage 104 with a pivot pin 84 extending along the first pivot P₁. The second rear pivot bracket 100 is pivotally connected to the rear linkage 104 with a pivot pin 84 extending along the second pivot P₂.

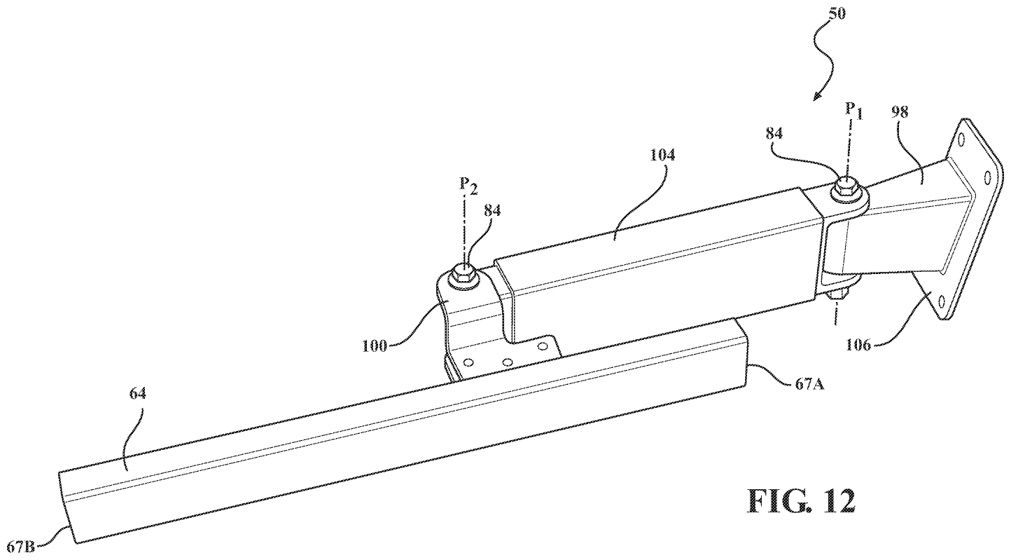

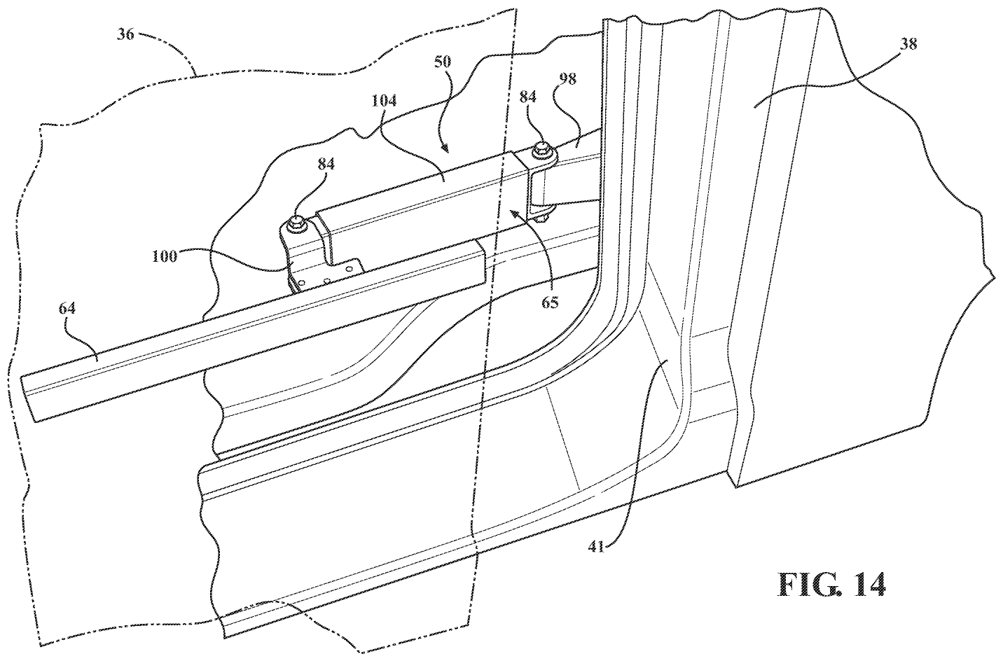

FIGS. 13A, 13B, 15A and 15B illustrate the lower rear door slide assembly 50 when the rear sliding door 36 is slid into the open position wherein the rear linkage 104 is disposed at a generally transverse angle from the from the lower rear rail 60 as well as the vehicle body 32 and the rear sliding door 36 (providing a similar range of movement as the arched portion 94 of the upper rear rail 60, as will be described in more detail below). FIG. 3 is a top view of the sliding door system 30 also illustrating the rear linkage 104 disposed at this generally transverse angle. As illustrated by the arrow, movement of the rear sliding door 36 in the “O” direction slides the rear sliding door 36 relative to the vehicle body 32 and rearward of the door frame opening 43. In some embodiments, the rear sliding door 36 may move completely rearward of the door frame 38. FIGS. 12 and 14 illustrate the lower rear door slide assembly 50 when the rear sliding door 36 is in the closed position wherein the rear linkage 104 is disposed at a parallel angle from the lower rear rail 64 (providing a similar range of movement as the straight portion 92 of the upper rear rail 60 in the upper rear door slide assembly 48) as will be described in more detail below).

As best illustrated in FIGS. 2-3, each of the front and rear sliding doors 34, 36 include at least one pillar support 68A, 68B extending from a top door portion 69 to a bottom door portion 71 of the respective front or rear sliding doors 34, 36 and which is arranged generally perpendicular to the upper and lower door slide assemblies 44, 46, 48, 50. As best illustrated in FIG. 2, the standard b-pillar present in the prior art arrangements is eliminated, and the full function of this b-pillar is incorporated into the front and rear sliding doors 34, 36 eliminating it from the body side. Thus, the front and rear sliding doors 34, 36 provide for the side impact performance for the vehicle. Additionally, as best shown in FIG. 2, with both of the front and rear sliding doors 34, 36 slid to their open positions, the elimination of the traditional b-pillar provides for improved ingress and egress into the vehicle interior, while also improving access around the vehicle in a parking lot. As further illustrated in FIG. 3, additional pillar supports 68C, 68D may also be located in the vehicle body 32 adjacent to the frame opening 43 and the front sliding door 34 connection and the rear sliding door 36 connection.

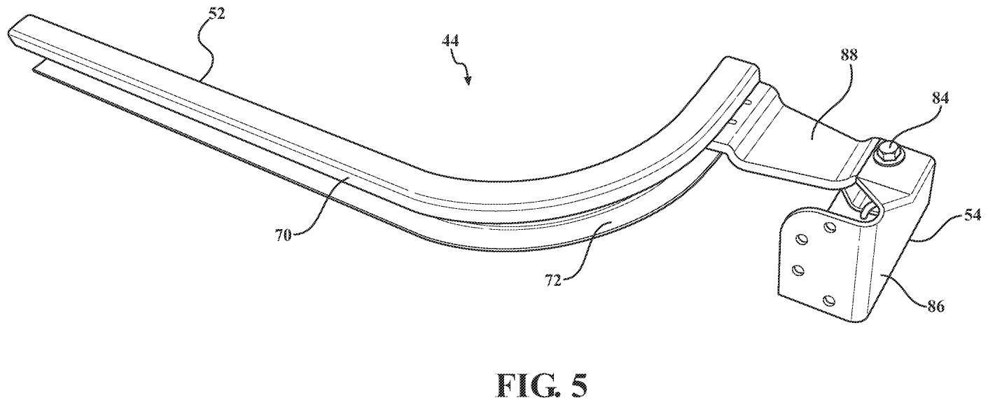

In more detail with regard to the upper front and rear door slide assemblies 44, 48, as best illustrated in FIGS. 4-5, the upper front carriage 54 of the upper front door slide assembly 44 slides within the upper front rail 52 relative to the vehicle body 32. The upper front rail 52 preferably includes a straight portion 70 and an arched portion 72. The arched portion 72 extends from the straight portion 70 and terminates at an upper front carriage housing 74 defined by the vehicle body 32 (e.g., adjacent to the door frame 38). In use, the upper front carriage 54 resides within the upper front carriage housing 74 when the front sliding door 34 is located in the closed position. When the front door 34 is opened, the upper front carriage 54 moves from the upper front carriage housing 74, along the arched portion 72 to move the front sliding door 34 outwardly from the vehicle body 32, and into and along the straight portion 70 to move the front door 34 away from the door frame 38. In some embodiments, the upper front rail 52 may define a C-shaped cross-section.

FIG. 5 is a perspective and isolated view of the upper front door slide assembly 44 illustrating additional features of the upper front carriage 54. More particularly, the upper front carriage 54 includes an upper front pivot bracket 86 for connection to the front door 34 and pivotally connected (e.g., with a pivot pin 84) to a upper front slide 88 that is slidably connected to the upper front rail 52.

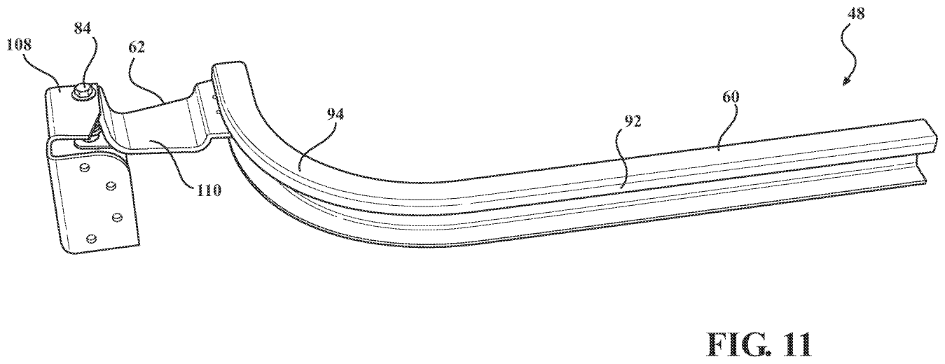

As best illustrated in FIGS. 10-11, the upper rear carriage 62 of the upper rear door slide assembly 48 slides within the upper rear rail 60 relative to the vehicle body 32. Similar to the upper front rail 52, the upper rear rail 60 also includes a straight portion 92 and an arched portion 94. The arched portion 94 extends from the straight portion 92 and terminates at an upper rear carriage housing 96 defined by the vehicle body 32 (e.g., adjacent to the door frame 38). In use, the upper rear carriage 62 resides within the upper rear carriage housing 96 when the rear sliding door 34 is located in the closed position. When the rear sliding door 36 is opened, the upper rear carriage 62 moves from the upper rear carriage housing 96, along the arched portion 94 to move the rear sliding door 36 outwardly from the vehicle body 32, and into and along the straight portion 92 to move the front door 34 away from the door frame 38. In some embodiments, the upper rear rail 90 may define a C-shaped cross-section.

FIG. 11 is a perspective and isolated view of the upper rear door slide assembly 48 illustrating additional features of the upper rear carriage 62. More particularly, the upper rear carriage 62 includes upper rear pivot bracket 108 for connection to the rear door 36 and pivotally connected (e.g., with a pivot pin 84) to an upper rear slide 110 that is slidably connected to the upper rear rail 60.

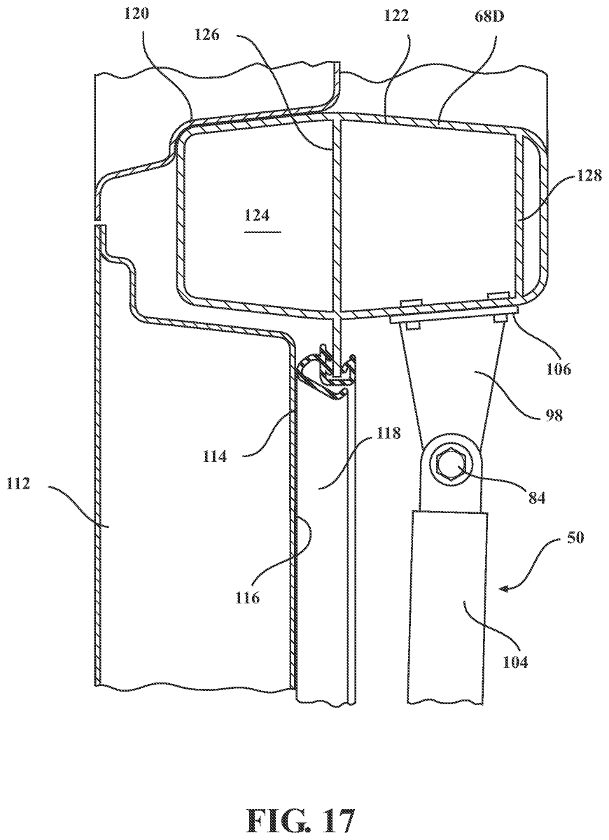

FIG. 16A is a perspective view of the lower rear door slide assembly 50 and the rear door 36 in the closed position, and FIG. 16B is a perspective view of the lower front door slide assembly 46 in the closed position. The rear sliding door 36 includes an outer panel 112 facing an environment of the vehicle and an inner panel 114 covering a portion of the door frame opening 43 and facing an interior of the vehicle in the closed position. The inner panel 114 defines a depression 116 that the lower rear rail 64 is located in, either partially or completely. As best illustrated in FIG. 16B, an inner panel 114 of the front sliding door 34 could similarly define a depression 116 in which the lower front rail 56 is disposed within, either partially or completely. The first rear pivot bracket 98 and the brace 106 are spaced from the inner panel 114. A seal path 118 is located between the rear door 36 and the first rear pivot bracket 98 and the brace 106. The seal path 118 is similarly located between the front door 34 and the first front pivot bracket 76. As such, the entire seal path 118 is preserved between opening and closing to prevent noise and susceptibility to leakage. FIG. 17 is a top view of the lower rear door slide assembly 58 connected to the door frame 38 of the vehicle body 32 and, more particularly, the pillar 68D. The pillar 68D (and in some embodiments, the other pillars 68A-68C) includes a first portion 120 and a second portion 122 defining a cavity 124 with a first webbing 126 extending centrally between the first portion 120 and a second portion 122 and a second webbing 128 adjacent to the brace 106.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. A sliding door system for a vehicle comprising:
a door frame defining a door opening;
a sliding door covering at least a portion of said door opening in a closed position;
an upper door slide assembly and a lower door slide assembly collectively interconnecting said sliding door to said door frame and each configured to slide said sliding door relative to said door frame from the closed position to an open position to dispose said sliding door either forward or rearward of said door opening; and
said lower door slide assembly including a lower track extending along said sliding door and a lower hinge assembly pivotably connected to said door frame and slideably mated with said lower track for effectuating pivoting and sliding movement of said sliding door between the open and closed positions.

2. The sliding door system as set forth in claim 1, wherein said lower hinge assembly includes a pair of lower pivots disposed in spaced relationship with one another between said door frame and said lower track for establishing a dual-pivoting movement of said lower hinge assembly during said sliding movement of said sliding door between the open and closed positions.

3. The sliding door system as set forth in claim 2, wherein said lower hinge assembly includes a first lower pivot bracket secured to said door frame and establishing a first lower pivot of said pair of lower pivots, a second lower pivot bracket slideably mated with said lower track and establishing a second lower pivot of said pair of lower pivots, and a linkage extending between said first and second lower pivot brackets.

4. The sliding door system as set forth in claim 3, wherein said lower track extends longitudinally from a first lower track end to a second lower track end, and said second lower pivot bracket includes a lower carriage slideably mated with said lower track and slideable along said lower track between said first and second lower track ends during said sliding movement of said sliding door between the open and closed positions.

5. The sliding door system as set forth in claim 4, wherein said lower carriage includes a wheel disposed within said lower track.

6. The sliding door system as set forth in claim 1, wherein said sliding door is a front sliding door.

7. The sliding door system as set forth in claim 1, wherein said sliding door is a rear sliding door.

8. The sliding door system as set forth in claim 1, wherein said sliding door includes at least one pillar support extending from a top door portion to a bottom door portion of said sliding door and arranged generally perpendicular to said lower track.

9. The sliding door system as set forth in claim 1, wherein said sliding door includes an inner panel defining a depression, and said lower track extending longitudinally in said depression.

10. A sliding door system for a vehicle comprising:
a door frame defining a door opening;
a front sliding door and a rear sliding door collectively covering said door opening in respective closed positions;
a front upper door slide assembly and a front lower door slide assembly interconnecting said front sliding door to said door frame and each configured to collectively slide said front sliding door relative to said door frame from the respective closed position to a front open position to dispose said front sliding door forward of said door opening;
a rear upper door slide assembly and a rear lower door slide assembly interconnecting said rear sliding door to said door frame and each configured to collectively slide said rear sliding door relative to said door frame from the respective closed position to a rear open position to dispose said rear sliding door rearward of said door opening;
said front lower door assembly including a front lower track extending along said front sliding door and a front lower hinge assembly pivotably connected to said door frame and slideably mated with said front lower track for effectuating pivoting and sliding movement of said front sliding door between the respective open and closed positions.
and said rear lower door assembly including a rear lower track extending along said rear sliding door and a rear lower hinge assembly pivotably connected to said door frame and slideably mated with said rear lower track for effectuating pivoting and sliding movement of said rear sliding door between the respective open and closed positions.

11. The sliding door system as set forth in claim 10, wherein each of said front and rear lower hinge assemblies includes a pair of lower pivots disposed in spaced relationship with one another between said door frame and said respective one of said front and rear lower tracks for establishing a dual-pivoting movement of said respective front or rear lower hinge assembly during said sliding movement of said respective front or rear sliding door between the open and closed positions.

12. The sliding door system as set forth in claim 11, wherein each of said front and rear lower hinge assemblies includes a first lower pivot bracket secured to said door frame and establishing a first lower pivot of said respective pair of lower pivots, a second lower pivot bracket slideably mated with said respective one of said front or rear lower tracks and establishing a second lower pivot of said respective pair of lower pivots, and a linkage extending between said first and second lower pivot brackets.

13. The sliding door system as set forth in claim 12, wherein each of said front and rear lower tracks extends longitudinally from a first lower track end to a second lower track end, and said second lower front pivot bracket of each of said front and rear hinge assemblies including a lower carriage slideably mated with said respective front or rear lower track and slideable along said respective front or rear lower tracks between said first and second lower track ends during said sliding movement of said respective front or rear sliding door between the open and closed positions.

14. The sliding door system as set forth in claim 13, wherein said lower carriage of said front and rear hinge assemblies includes a wheel disposed within said respective lower front or rear track.

15. The sliding door system as set forth in claim 10, wherein each of said front and rear sliding door includes at least one pillar support extending from a top door portion to a bottom door portion of said respective front or rear sliding door and arranged generally perpendicular to said respective front or rear lower track.

16. The sliding door system as set forth in claim 4, wherein said linkage is disposed at a generally transverse angle relative to said lower track when said sliding door is disposed in the open position.

17. The sliding door system as set forth in claim 4, wherein said linkage is disposed at a generally parallel angle relative to said lower track when said sliding door is disposed in the closed position.

18. The sliding door system as set forth in claim 1, wherein said upper door assembly includes an upper track extending away from said door opening and an upper carriage connected to said sliding door and slideably disposed within said upper track for sliding within said upper track during movement of said sliding door between the open and closed positions.

19. The sliding door system as set forth in claim 18, wherein said upper track includes an arched portion disposed adjacent said door opening and a straight portion connected to an extending away from said arched portion and said door opening.

20. The sliding door system as set forth in claim 19, wherein said arched portion of said upper track terminates at an upper carriage housing defined by said door frame adjacent said door opening, and said upper carriage disposed in said upper carriage housing when said sliding door is disposed in the closed position.
